(19) United States
(12) Patent Application Publication
(10) Pub. No.: US 2021/0398109 A1
(43) Pub. Date: Dec. 23, 2021

(54) GENERATING OBFUSCATED IDENTIFICATION TEMPLATES FOR TRANSACTION VERIFICATION

(71) Applicant: ID Metrics Group Incorporated, Kirkland, WA (US)

(72) Inventor: Richard Austin Huber, JR., Weehawken, NJ (US)

(21) Appl. No.: 17/354,949

(22) Filed: Jun. 22, 2021

Related U.S. Application Data
(60) Provisional application No. 63/042,476, filed on Jun. 22, 2020.

(51) Int. Cl. G06Q 20/38; G06N 3/08; G06N 3/04; G06K 9/00

(52) U.S. Cl. CPC G06Q 20/383; G06N 3/08; G06K 19/06028; G06K 9/00442; G06N 3/04

(57) ABSTRACT

Methods, systems, and apparatus, including computer programs encoded on computer-storage media, for identification templates for identification search and authentication. In some implementations, obtaining first data that represents a physical document identifying a party to a transaction, providing the first data as an input to a machine learning model that comprises at least one hidden layer that is a trained security feature discriminator layer, obtaining activation data generated by the security feature discriminator layer based on the machine learning model processing the first data, determining based on the obtained activation data, that the transaction is to be denied, and based on determining that the transaction is to be denied, generating a notification that, when processed by the computer, causes the computer to output data indicating that the transaction is to be denied.

### CROSS-REFERENCE TO RELATED APPLICATION

This application claims the benefit under 35 U.S.C. § 119(e) of U.S. Patent Application No. 63/042,476, entitled “GENERATING OBFUSCATED IDENTIFICATION TEMPLATES FOR TRANSACTION VERIFICATION,” filed Jun. 22, 2020, which is incorporated herein by reference in its entirety.

### BACKGROUND

Persons can create counterfeit documents for a variety of reasons. Detection of such counterfeit documents is an important operation for many entities including financial services organizations, retail outlets, government agencies, among many others.

### SUMMARY

According to one innovative aspect of the present disclosure, a method for transaction verification is disclosed. In one aspect, the method can include actions of obtaining, by one or more computers, first data that represents at least a portion of a physical document identifying a party of a transaction, providing, by the one or more computers, the first data as an input to a machine learning model that comprises a security feature discriminator layer that is configured to detect the presence of one or more security features in data representing an image of at least a portion of a physical document or the absence of one or more security features in data representing an image of at least a portion of a physical document, obtaining, by the one or more computers, activation data generated by the security feature discriminator layer based on the machine learning model processing the first data, determining, by the one or more computers and based on the obtained activation data, that the transaction is to be denied, and based on determining that the transaction is to be denied, generating, by the one or more computers, a notification that, when processed by the computer, causes the computer to output data indicating that the transaction is to be denied.

Other versions can include corresponding systems, apparatuses, and computer programs to perform, or otherwise realize, the actions of methods defined by instructions encoded on computer readable storage devices.

These and other versions may optionally include one or more of the following features. For instance, in some implementations, determining, by the one or more computers and based on the obtained activation data, that the transaction is to be denied can include determining, by the one or more computers, that the obtained activation data matches second data stored in a database of entity records within a predetermined error threshold, wherein each entity record in the database of entity records corresponds to an entity whose transactions are to be denied for at least a predetermined amount of time.

In some implementations, the method can further include obtaining, by one or more computers, third data that represents at least a portion of a physical document identifying a different party of a different transaction, providing, by the one or more computers, the third data as an input to the machine learning model, obtaining, by the one or more computers, different activation data generated by the security feature discriminator layer based on the machine learning model processing the third data, determining, by the one or more computers and based on the obtained different activation data that the transaction is not to be denied, and based on determining that the transaction is not to be denied, generating, by the one or more computers, a notification that, when processed by the computer, causes the computer to output data indicating that the transaction is not to be denied.

In some implementations, determining, by the one or more computers and based on the obtained different activation data that the transaction is not to be denied can include determining, by the one or more computers, that the obtained different activation data matches fourth data stored in a database of entity records within a predetermined error threshold, wherein each entity record in the database of entity records corresponds to an entity whose transactions are to be authorized for at least a predetermined amount of time.

In some implementations, determining, by the one or more computers and based on the obtained different activation data that the transaction is not to be denied can include determining, by the one or more computers, that the obtained different activation data does not match data stored in a database of entity records within a predetermined error threshold, wherein each entity record in the database of entity records corresponds to an entity whose transactions are to be denied for at least a predetermined amount of time.

In some implementations, the method can also include obtaining, by the one or more computers, output data generated by the machine learning model based on the machine learning model processing the first data, wherein the output data indicates a likelihood that the first data represents an image that depicts at least a portion of a legitimate physical document.

In some implementations, the security feature discriminator layer is a hidden layer of the machine learning model.

In some implementations, the machine learning model can include one or more neural networks.

In some implementations, the method can further include receiving, by the security feature discriminator layer, second data representing at least the portion of a physical document identifying a party of a transaction, generating, using the security feature discriminator layer, the activation data. In some implementations, generating the activation data can include encoding, using the security feature discriminator layer, data representing the presence of one or more security features in the second data or the absence of one or more security features in the second data.

In some implementations, the second data is the same as the first data.

In some implementations, the second data is different than the first data.

In some implementations, the second data is received from an input layer of the machine learning model.

In some implementations, the second data is received from a preceding hidden layer of the machine learning model.

In some implementations, the security feature is an attribute of a physical document that is indicative of the legitimacy of the physical document.

In some implementations, a security feature can include (i) a facial orientation of a face in a profile image of a physical document represented by the first data, (ii) a material of a physical document represented by the first data, (iii) a text feature of a physical document represented by the first data, (iv) a 2D PDF-417 encoding, a bar code, or a QR-code, or a (v) drop shadow.

In some implementations, a security feature can include a spatial relationship between multiple other security features.

According to another aspect of the present disclosure, another method for transaction verification. In one aspect, the method can include obtaining, by one or more computers, first data that represents at least a portion of a physical document identifying a party of a transaction, obtaining, by the one or more computers, second data that represents a facial image of the party, providing, by the one or more computers, the first data as an input to a machine learning model that has been trained to determine a likelihood that data representing an input image depicts at least a portion of a legitimate physical document, the machine learning model including a security feature discriminator layer that is configured to detect the presence of a document security feature of a document or the absence of the document security feature, obtaining, by the one or more computers, first activation data generated by the security feature discriminator layer based on the machine learning model processing the first data, providing, by the one or more computers, the second data as an input to the machine learning model, obtaining, by the one or more computers, second activation data generated by the security feature discriminator layer based on the machine learning model processing the second data, determining, by the one or more computers, and based on (i) the obtained first activation data and (ii) the obtained second activation data, that the transaction is to be denied, and based on determining that the transaction is to be denied, generating, by the one or more computers, a notification that, when processed by the computer, causes the computer to output data indicating that the transaction is to be denied.

Other versions include corresponding apparatus, methods, and computer programs to perform the actions of methods defined by instructions encoded on computer readable storage devices.

These and other versions may optionally include one or more of the following features. For instance, in some implementations, determining, by the one or more computers and based on (i) the obtained first activation data and (ii) the obtained second activation data, that the transaction is to be denied can include determining, by the one or more computers, a level of similarity between (i) the obtained first activation data and (ii) the obtained second activation data, determining, by the one or more computers, that the level of similarity fails to satisfy a predetermined threshold, and based on determining, by the one or more computers, that the level of similarity fails to satisfy a predetermined threshold, determining that the transaction is to be denied.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a contextual diagram of an example of a system for generating identification templates.

FIG. 2 is a flowchart of an example of a process for generating identification templates.

FIG. 3 is a contextual diagram of an example of a system for authenticating a user's identity using identification templates.

FIG. 4 is a flowchart of an example of a process for authenticating a user using identification templates.

FIG. 5 is a block diagram of system components that can be used to implement generate and use identification templates.

Like reference numbers and designations in the various drawings indicate like elements.

### DETAILED DESCRIPTION

The present disclosure is directed towards methods, systems, and computer programs for generating an obfuscated user identification template that can be used for user authentication operations. In some implementations, the user identification template can include activation data output by a hidden layer of a machine learning model that has been trained to determine a likelihood that input data representing an image depicts at least a portion of a legitimate physical document. The activation data itself, which is generated by a hidden layer of the machine learning model as the machine learning model processes input data representing an image of a physical document, can be used to uniquely identify a person linked to a physical document depicted by the image represented by the input data processed by the machine learning model. The identification template is secure and cannot be decoded to reveal the image of a physical document that was processed by the machine learning model to cause the hidden layer of the machine learning model to generate the activation data. Thus, this identification template provides significant security advantages in applications that can include sharing of customer information across customer or transaction verification platforms.

Though the obfuscated user identification template can conceal the identity of a person linked to a physical document in instances where the obfuscated user identity template is shared across computing platforms—it is important to note that the obfuscated user identification template is not “encrypted data.” Such encrypted data is typically generated by applying an encryption algorithm to target data to conceal the content of the target data. This is significant because target data that has been encrypted using an encryption algorithm can be decrypted using one or more of a decryption algorithm, private key, the like, or some combination thereof. In contrast, the user identification template of the present disclosure is generated using activation data output by a hidden layer of a machine learning model trained to determine a likelihood that input data representing an image depicts at least a portion of a legitimate physical document. This activation data cannot be decoded to, for example, reveal the image of a physical document that was processed by the machine learning model to cause the hidden layer of the machine learning model to generate the activation data—even if one is in possession of the machine learning model. This makes the obfuscated user identification template described herein ideal for sharing across customer or transaction authentication/verification platforms while protecting the identity of the person linked to the physical document that was processed to generate the activation data.

In accordance with one aspect of the present disclosure, a machine learning model can be trained to determine a likelihood that input data representing an image of at least a portion of a physical document depicts at least a portion of a legitimate physical document. A legitimate physical document is a document that is created to comply with a legitimate anticounterfeiting architecture. A counterfeit physical document is a document that is created without complying with a legitimate anticounterfeiting architecture. A legitimate anticounterfeiting architecture, which may be referred to herein as an “anticounterfeiting architecture,” can include a group of two or more anticounterfeiting security features whose collective presence or absence in an image of a physical document provide an indication of the physical document's legitimacy. For purposes of this disclosure, a physical document can include a driver's license, a passport, or any form of physical identification that includes a facial image of a person identified by the form of physical identification. “Security features” of an anticounterfeiting architecture is a term that refers to a feature of an anticounterfeiting architecture whose presence or absence in an image of a physical document can be detected by a machine learning model trained in accordance with the present disclosure.

In some implementations, a security feature discriminator layer of the machine learning model can be used to detect the presence of a security feature of a document, the absence of a document security feature, incorrect security features, or abnormal security features. In accordance with the present disclosure, a security feature can be any attribute of a physical document that is indicative of the legitimacy of the physical document. Security features can include presence, absence, or placement of natural background, artificial background, natural lighting, artificial lighting, natural shadow, artificial shadow, absence of flash shadow such as a drop shadow, head size abnormalities, head aspect ratio abnormalities, head translation abnormalities, abnormal color temperatures, abnormal coloration, aligned and configured flash lighting, off-angle illumination, focal plan abnormalities, bisection of a focal plane, use of fixed focal length lenses, imaging effects related to requanitization, imaging effects related to compression, abnormal head tilt, abnormal head pose, abnormal head rotation, non-frontal facial effects, presence of facial occlusions such as glasses, hats, head scarfs, or other coverage, abnormal head shape dynamics, abnormal head aspect ratio to intereye distances, abnormal exposure compensation between foreground and background, abnormal focus effects, image stitching effects indicating different digital sources, improper biometric security feature printing, improper security feature layering such as improper OVD, OVI, hologram, other secondary security feature overlays over a face or other portion of a document, improper tactile security feature placement near face, over a face, or other portion of a document, improper final face print, improper laser black and white, improper color laser, improper layered ink print, improper printing techniques, improper print layer sequencing, improper materials used to construct the physical document, a threshold level of material degradation of the physical document (e.g., scratches, cuts, bends, color fading, color bleeding, or the like), text features of a physical document (e.g., name, address, biographical information, or another other text), a 2D PDF-417 encoding, other form of bar code or QR code, placement of the 2D PDF-417 /bar code/QR code, or the like. In some implementations, a security feature may include a relation such as a spatial relationship between two or more security features. This list of security features is not exhaustive and other types of security features can exist or be created that fall within the scope of the present disclosure.

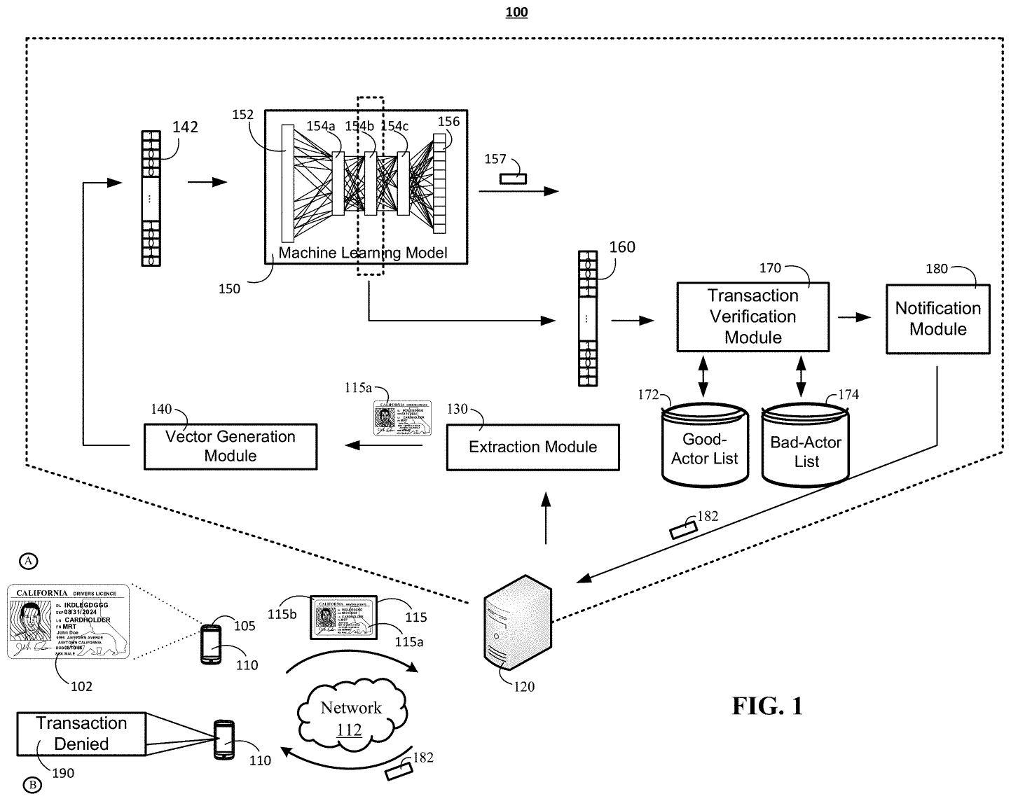

FIG. 1 is a contextual diagram of an example of a system 100 for generating identification templates. The system 100 can include a user device 110, a network 112, and a server 120. The user device 110 can be, for example, a smartphone. The user device 110 can communicate with the server 120 using one or more networks 112. The server 120 can include an extraction module 130, a vector generation module 140, a machine learning model 150, a transaction verification module 170, a good-actor list 172, a bad-actor list 174, and a notification module 180. Each of the components of the system 100 can be hosted on a single computer or hosted across multiple computers that are configured to communicate with each other using one or more networks. For purposes of this specification, a “module” can include software, hardware, or any combination thereof, that is configured to perform the functionality attributed to the “module” by the present disclosure. The system 100 is described as a process from stage A to stage B.

With reference to the example of FIG. 1, the user device 110 can capture an image 115 of the physical document 102 using the camera 105 at stage A. The image 115 can include a first portion 115a that depicts at least a portion of the physical document 102 and a second portion 115b that depicts a portion of the surrounding environment when the image 115 of the physical document 102 was captured. The user device 110 can transmit the image 115 to the server 120 using the network 112. The network 112 can include a wired network, a wireless network, a LAN, a WAN, a cellular network, the Internet, or any combination thereof.

Though the example of FIG. 1 shows a user device 110 in the form of smartphone being used to capture the image 115, the present disclosure should not be so limited. For example, instead of the smartphone, a camera without voice calling capabilities can be used to capture the image 115. Then, the camera can transmit the image 115 to the server 120 using the network 112. In other implementations, the camera without voice calling capabilities may capture the image 115 and communicate the image 115 to another a computer. This be achieved via one or more networks such as a Bluetooth shortwave radio network or via a direct connection to the computer using, for example, a USBC cable. Then, in such implementations, the computer can be used to transmit the image 115 to the server 120 using the network 112. In yet other implementations, the camera can be part of another user device such as a tablet, a laptop, smart glasses, or the like, each of which can be equipped with a camera and image transmitting device. In general, any device capable of capturing images can be used to capture an image such as the image 115.

The server 120 can receive image 115 and provide the image 115 as an input to the extraction module 130. The extraction module 130 can extract the first portion 115a of the image physical document from the image 115 and discard the second portion 115b of the image 115. This functionality can serve the purpose of removing portions of the image 115 that do not depict a portion of the physical document 102. However, in other implementations, the extraction module 130 can be used to extract only portion of the first portion 115a of the image 115. For example, the extraction module 130 can be configured to only extract the profile image of a person's face from the first portion 115a of the image 115. Indeed, the extraction module can be configured to extract any portion of the first portion 115a of the image 115 depicting at least a portion of the physical document 102 for use in generating the identification template described herein. The first portion 115a of the image 115 may also be referred to herein as image 115a.

The server 120 can provide the extracted portion of the image 115 to the vector generation module 140. With reference to the example of FIG. 1, the extracted portion of the image 115 includes the first portion 115a of the image 115. In this example, the extracted portion of the image 115 includes an image of the physical document 102 after the second portion 115b of the image 115 has been removed. The vector generation module 140 can process the extracted portion of the image 115a and generate a vector 142 that numerically represents the extracted portion of the image 115a. For example, the vector 142 can include a plurality of fields that each correspond to a pixel of the extracted portion of the image 115a. The vector generation module 140 can determine a numerical value for each of the fields that describes a corresponding pixel of the extracted portion of the image 115a. The determined numerical values for each of the fields can be used to encode the security features of the anticounterfeiting architecture of the physical document 102 depicted by the extracted portion of the image 115a into a generated vector 142. The generated vector 142, which numerically represents the extracted portion of the image 115a, is provided as an input to the machine learning model 150.

The machine learning model 150 can include any machine learning model that processes data through multiple layers such as, e.g., one or more neural networks. The machine learning model 150 includes a number of layers. These layers can include an input layer 152 that is used for receiving input data e.g. the input vector 142, one or more hidden layers 154a, 154b, or 154c that are used to process the input data received via the input layer 152, and an output layer 156 such as a softmax layer. Each hidden layer 154a, 154b, or 154c of the machine learning model 150 can include one or more weights or other parameters. The weights or other parameters of each respective hidden layer 154a, 154b, or 154c can be adjusted so that the trained model produces the desired target vector corresponding to each set of training data. The output of each hidden layer 154a, 154b, or 154c can include an activation data. In some implementations, this activation data can be represented as an activation vector comprising a plurality of fields that each represent a numerical value generated by the hidden layer. The activation vector output by each respective hidden layer can be propagated through subsequent layers of the model and used by the output layer to produce output data 157. In some implementations, the output layer 156 can perform additional computations on a received activation vector from the final hidden layer 154c in order to generate neural network output data 157.

Though the example of FIG. 1 only shows three hidden layers 154a, 154b, and 154c, the present disclosure is not so limited. One or more hidden layers may constitute a full array of hidden layers within the machine learning model 150. Thus, the number of hidden layers may be less than, equal to, or greater than the three hidden layers shown in FIG. 1.

The machine learning model 150 can be trained to configure one or more of the hidden layers 154a, 154b, or 154c to function as a security feature discriminator layer. A security feature discriminator layer can include one or more hidden layers of a deep neural network that have been trained to include security feature discriminators. Each security feature discriminator can be configured to detect the presence or absence of a particular security feature of an anticounterfeiting architecture. Detecting the presence or absence of a particular security feature of an anticounterfeiting architecture can include detecting the presence or absence of a single security feature. However, in some implementations, detecting the presence or absence of particular security feature can include detecting relationships such as spatial relationships between multiple different security features. Thus, a security feature discriminator of the security feature discriminator layer can be trained to detect, as a security feature, whether or not a group of one or more security features are placed within a particular location of a physical document individually or with reference to one or more other security features. The one or more hidden layers 154a, 154b, or 154c can be trained to include a security feature discriminator layer using an autoencoding process.

Autoencoding is a training process for generating one or more deep neural network layers that uses a feedback loop for adjusting weights or other parameters of a deep neural network layer until the deep neural network output layer begins to drive deep neural network output data that accurately classifies labeled input data processed by the deep neural network into a particular class specified by the label of the input data. In some implementations, the output data can include a similarity score. The output similarity score can then be evaluated such as by applying one or more thresholds to the output similarity score to determine a class for the input data. With reference to FIG. 1, the vector 142 that represents the image 115a is input into the input layer 152 of the machine learning model 150, processed through each layer of the machine learning model 150, and output data 157 is generated based on the machine learning model's 150 processing of the vector 142.

The autoencoding of the one or more hidden layers 154a, 154b, 154c as security feature discriminator layers can be achieved by performing multiple iterations of obtaining a training image that depicts at least a portion of a physical document from a training database, extracting a portion of the training image for use in training the machine learning model 150 (if relevant portion of training image has not already been extracted), generating an input vector based on the extracted portion of the training image, using the machine learning model 150 to process the generated input vector, and execute a loss function that is a function of the output generated by the machine learning model 150 and a label of the training image that corresponds to the training image represented by the input data vector processed by the machine learning model 150. The system 100 can adjust values of parameters of the machine learning model 150 based on outputs of the loss function at each iteration in an effort to minimize the loss function using techniques such as stochastic gradient descent with backpropagation or others. The iterative adjusting of values of parameters of the machine learning model 150 based on the output of the loss function is a feedback loop that tunes values of weights or other parameters of one or more of the hidden layers 154a, 154b, and 154c until the output data begins to match, within a predetermined amount of error, the training label of an image corresponding to the input data vector processed by the machine learning model 150 to produce the output data.

In the example shown in FIG. 1, an activation data 160 is shown as output of hidden layer 154b. The activation data 160 is the output activation data generated by the hidden layer 154b based on the hidden layer 154b processing input data that it received. In the present disclosure, the hidden layer 154b is a security feature discriminator layer trained to detect the presence of a document security feature of a document or the absence of the document security feature. As a point of distinction, the activation data 160 obtained from the hidden layer 154b (e.g., a security feature discriminator layer) is generated by the hidden layer 154b (e.g., a security feature discriminator layer) and output by the hidden layer 154b (e.g., a security feature discriminatory layer). The activation data 160 is not the output 157 of an output layer 156 of the machine learning model 150.

The security feature discriminator layer can receive and process a representation of an extracted image portion 115a. In some implementations, the representation of the extracted image portion 115a that the security feature discriminator layer receives and processes can include the input vector 142 that can be provided to the security feature discriminator layer directly or as an output of a preceding layer such as the input layer 152. In some implementations, representation of the extracted image portion 115a received and processed by the security feature discriminator layer can include the output of another hidden layer such as hidden layer 154a. Regardless of its precise origin, form, or format, the input data received and processed by the security feature discriminator layer represents the extracted image portion 115a.

The output data generated by the security feature discriminator layer (e.g., hidden layer 154b) based on the security feature discriminator layer processing input data representing the extracted image portion 115a is the activation data 160. Generation of the activation data 160 by the security feature discriminator layer (e.g., hidden layer 154b) includes encoding, by the security feature discriminator layer (e.g., hidden layer 154b), data representing the presence or absence of security features of an anticounterfeiting architecture depicted in an image of a physical document (e.g., extracted image portion 115a) that corresponds to the input data processed by the security feature discrimination layer.

The activation data 160 can be used as an obfuscated identification template for the physical document 102, at least a portion of which is depicted by the extracted image portion 115a and represented by the input vector 142. In some implementations, the activation data 160 can include data produced by a particular hidden layer (e.g., a security feature discriminator layer). This data produced by the particular hidden layer can represent a set of parameters produced by processing elements such as neurons of the particular hidden layer (e.g., security feature discriminator layer) based on the particular hidden layer processing input data representing extracted image portion 115a. By way of example, the set of parameters can include outputs of one or more neurons of the hidden layer, weights related to such outputs, the like, or any combination thereof. In one implementation, for example, the activation data 160, and other activation data discussed in this specification, can be an extracted binary of particular image data represented by the input vector 142, weights or values produced by respective neurons of the hidden layer (e.g., security feature discriminator layer) related to the extracted binary, or a combination thereof. In such implementations, the binary values can correspond to specific features of an extracted image portion 115a that are recognized by the particular implementation of a security feature discriminator layer based on processing data representing the extracted image portion 115a and can include information such as whether a particular security feature is present or absent in the data representing the extracted image portion 115a that is processed by the security feature discriminator layer.

The activation data 160 output by a security feature discriminator layer (e.g., a hidden layer 154a, 154b, or 154c) is encoded with data indicating whether each of one or more security features, of a particular anticounterfeiting architecture on which the security feature discriminator layer was trained, are present or absent in the input data representing the extracted image portion 115a that was processed by the security feature discriminator layer. The encoding of the presence or absence of the security features of a particular anticounterfeiting architecture, by the security feature discriminator layer, into the activation data 160 creates an obfuscated identification template that represents the physical identification document that corresponds to the extracted image portion 115a.

An obfuscated identification template can uniquely identify a particular physical identification document (e.g., physical document 102), with even the slightest differentiation in security features of a physical document resulting in a different encoding of the activation vector. For example, a trained security feature discriminator layer can generate a different activation vector for respective images of a physical document based on subtle distinctions such as different head position of profile images in the images of the physical documents, different lighting conditions in the images of the physical documents, different spatial relationships of security features in the images of the physical documents, different ink characteristics of text/graphics/images in images of the physical documents, presence of a barcode in a first image of a physical document and absence of the barcode in the second image of the physical document, and the like. Though these examples are presented here, they are not intended to be limiting. Instead, these are provided to illustrate the point that any distinction between presence, absence, arrangement (e.g., spatial arrangement of one or more security features), or quality of security features (e.g., ink quality, print quality, materials quality, etc.) in images of different physical documents can be detected by the security feature discriminator layer and cause the security feature discriminator layer to generate a different set of activation data 160 as an output, thus enabling the activation data 160 to be used as an obfuscated identification template corresponding to a particular physical document.

In some implementations, the activation data 160 can be produced using unsupervised learning techniques. For example, because of the use of unsupervised learning, the weighting and composition of generated activation data such as the activation data 160 generated by the hidden layer 154b during processing, by the machine learning model 150, of the input vector 142 that represents the extracted portion of the image 115a will be within a predetermined margin of error of another set activation data generated by the hidden layer 154b each subsequent time an input vector 142 representing the extracted portion of the image 115a is processed by the machine learning model 150. Thus, absent additional training, retraining, or a combination thereof, a hidden security feature discriminator layer 154b of the machine learning model 150 can reliably generate activation data that can be used as an identification template for the physical document 102.

This activation data 160 can uniquely identify a particular physical document shown by a party to a transaction. The unique identification property of the activation data arises as a result of the encoding of security features of the physical document 102 as depicted in an extracted portion of the image 115a. For example, in some implementations, the hidden layer 154b has been trained, for example, using the autoencoding process described herein, to detect the present or absence of security features of the security features of the physical document 102 as depicted by the extracted portion of the image 115a. As a result, the activation data 160 generated by the hidden security feature discriminator layer 154b and shown in this example as activation vector represents an encoding of data representing the presence, absence, arrangement, or quality of security features of the physical document 102 that are depicted by the extracted portion of the image 115a.

In some implementations, the encoded data can indicate that a security feature is present, but of low quality. Alternatively, in some implementations, the detection of a low quality security feature (e.g., poor lighting for profile image) may be encoded into the activation data as the absence of a security feature (e.g., appropriate lighting conditions). Similarity, the detection of appropriate lighting conditions in a profile image may be encoded into the activation data as the presence of a security feature (e.g., appropriate lighting conditions). Likewise, in some implementations, the encoded data can indicate that one or more security features were not spatially arranged in an appropriate manner. Alternatively, in some implementations, the detection of an improper spatial arrangement of one or more security features may be encoded into the activation data as the absence of a security feature (e.g., 2D PDF-417 not present where expected). Similarly, proper spatial location of one or more security features can be encoded into the activation data as the presence of a security feature (e.g., 2D PDF-417 present where expected).

The activation data 160 can provided as an input to the transaction verification module 170. The transaction verification module 170 can determine whether a transaction requested by the entity that presented the physical document 102 should be permitted or denied. The transaction verification module 170 can make this determination by determining whether the activation data 160 generated by the hidden layer 154b of the machine learning model 150 based on the machine learning model's 150 processing of the generated input vector 142 matches a corresponding vector stored in the good-actor list 172, the bad-actor list 174, or neither the good-actor list 172 or the bad-actor list 174.

The good-actor list 172 can include a database, data structure, or other organization of data that includes data describing one or more parties whose transactions should be authorized. A party may be added to a good-actor list for a number of reasons such as achieving a number of on-time payment or other legitimate transaction activity. The good-actor list 172, depending on implementation, may be used exclusively by a given organization within a local network of transactions or be provided more broadly to other situations or organizations. In some implementations, the data describing the party whose transaction should be authorized can include activation data previously generated by a hidden layer 154b of a machine learning model 150 or a hidden layer of another machine learning model that has been trained in the same manner as machine learning model 150. This activation data can be the output of a hidden layer of one of these machine learning models in the same manner as the activation data 160 shown in FIG. 1.

This stored activation data can function as an identity template of a physical document associated with an entity whose transactions have been pre-verified. In some implementations, data describing one or more parties whose transactions should be authorized may be stored in the good-actor list for only a predetermined amount of time such as 90 days. In such implementations, the transaction verification module 170 or other module such as a good-actor list maintenance module can be used to monitor time stamps associated with a creation date of identification templates stored in the good-actor list 172 and delete each identification template whose respective time stamp indicates a creation date that has met or exceed the predetermined amount of time for which the identity template is authorized to be stored in on the good-actor list 172.

The bad-actor list 173 can include a database, data structure, or other organization of data that includes data describing one or more parties whose transactions should be denied. A party may be added to a bad-actor list for a number of reasons such being associated with a risk factor beyond a certain threshold for a given transaction, set of transactions, or predetermined amount of time. By way of example, indicators like a request for a large loan, inability to pay back money or assets that were lent, canceling a credit card transaction for a purchase after receiving and keeping the goods associated with the purchase, or the like. The bad-actor list 174, depending on implementations, may be used exclusively by a given organization within a local network of transactions or be provided more broadly to other situations or organizations. In some implementations, the data describing the party whose transactions should be denied can include activation data previously generated by a hidden layer 154b of a machine learning model 150 or a hidden layer of another machine learning model that has been trained in the same manner as machine learning model 150. This activation data can be the output of a hidden layer of one of these machine learning models in the same manner as the activation data 160 shown in FIG. 1.

This stored activation data can function as an identity template of a physical document associated with an entity who has been pre-flagged for transaction denial. In some implementations, data describing one or more parties whose transactions should be denied may be stored in the bad-actor list for only a predetermined amount of time such as 90 days. In such implementations, the transaction verification module 170 or other module such as a bad-actor list maintenance module can be used to monitor time stamps associated with a creation date of identification templates stored in the bad-actor list 174 and delete each identification template in the bad-actor list whose respective time stamp indicates a creation date that has met or exceed the predetermined amount of time for which the identity template is authorized to be stored on the bad-actor list 174.

Use of identification templates stored on the good-actor list 172 or the bad-actor list 174 instead of an image of an entity's physical identification document provides significant security and privacy benefits—and indeed enables use of this system to privately store and share entity identification information in a secure manner. Not even encryption algorithms can achieve the level of security and privacy of the present disclosure, as it is at least possible for encrypted data to be decrypted.

The transaction verification module 170 can perform transaction verification by searching the good-actor list 172, a bad-actor list 174, or a combination of both in response to an activation data 160 received by the transaction verification module 170. For example, the transaction verification module 170 can perform a search of the good-actor list 172. In some instances, the transaction verification module 170 can determine that the activation data 160 matches, within a certain threshold of error, a given identification template in the good-actor list. In such instances, the transaction verification module 170 can determine that the entity that provided the physical document 102 as part of a transaction verification document, which is represented by the input vector 142, has been authenticated and the transaction of the party should be approved. Alternatively, in other instances, the transaction verification module 170 can determine that the activation data 160 does not match, within the certain threshold of error, then the transaction verification module 170 can continue the transaction verification process by performing a search of the bad-actor list 174.

Once the good-actor list 172 has been searched, the transaction verification module 170 can perform a search of the bad-actor list 174. In some instances, the transaction verification module 170 can determine that the activation data 160 matches, within a certain threshold of error, a given identification template in the bad-actor list. In such instances, the transaction verification module 170 can determine that the entity that provided the physical document 102 as part of a transaction verification document, which is represented by the input vector 142, is not authorized to complete the transactions. In such implementations, the transaction verification module 170 can instruct the notification module 180 to generate a notification 182 indicating that the transaction should be denied. In such instances, the server 120 can transmit the notification 182 to the requesting user device 110 for display on a display device of the user device at state B indicating that the transaction should be denied.

Alternatively, in other instances, the transaction verification module 170 can determine that the activation data 160 does not match any identification templates in the bad-actor list 174. In this scenario, the activation data 160 received by the transaction verification module 170 has determined that the activation data 160 does not match, within a certain threshold of error, any identification templates in the good-actor list or the bad-actor list. In such a scenario, the transaction verification module 170 can determine that the entity that provided the physical document 102 as part of a transaction verification document, which is represented by the input vector 142, is authorized to complete a requested transaction. In such implementations, the transaction verification module 170 can instruct the notification module 180 to generate a notification 182 indicating that the transaction is authorized and should be permitted. In such instances, the server 120 can transmit the notification to the requesting user device 110 for display on a display device of the user device at state B indicating that the transaction should be permitted.

In the example of FIG. 1, the same user device that captures the image 115 and transmits the image 115 to the server 120 also receives the notification 182. However, the present disclosure need not be so limited. Instead, in some implementations, a first user device can be used to capture and provide the image 115 to the server 320 and the server 320 can send the notification 382 to another different user device.

In the examples above, the transaction verification module has been used to determine whether a transaction should be denied or permitted. However, the present disclosure need not be so limited. Instead, in some implementations, the transaction verification module 170 can determine whether the transaction should be denied or whether the transaction is not to be denied. Determining that the transaction is not to be denied is different than actually permitting the transaction, as ultimate approval/disapproval of the transaction may rest of other factors. Accordingly, the transaction verification module 170 can give a definite approval if a runtime identification template is found on a good-actor list or a definite denial if a runtime identification template is found on a bad-actor list. However, in some implementations, if the runtime identification template is not found on either the good-actor list or the bad-actor list, the transaction verification module 170 may merely instruct the notification module 180 to generate a notification indicating that the transaction is not to be denied. That said, other implementations may also be configured to treat a scenario where the runtime identification template is not found on either the good-actor list or the bad-actor list as being indicative of a transaction that is to be permitted. The ultimate configuration can be determined based on a business model of a customer implementing the system 100.

As described above, a threshold amount of error is used when comparing (i) an identification template such as activation data 160 generated at runtime based on a physical document 102 presented by a party to (ii) previously generated identification templates stored on the good-actor list, bad-actor list, or both. This is because the respective identity templates may not be exact matches. Instead, each identification template, using the activation data upon which the identification template is based, can represent a particular vector in a vector space. In such a scenario, a comparison between an identification template generated at runtime and identification templates of a good-actor list or bad-actor list by evaluating a distances between the activation data of the newly generated identification template and the activation data of each stored identification template. If the distances between two identification templates satisfies a predetermined error threshold, then the two identification templates can be determined to be a match.

In some instances, the term “identification template” is used to describe a representation of a physical document such as physical document 102. In addition, the term “activation data” or “activation vector” is used to describe the output of a hidden layer of the machine learning model 150. However, it is noted that in some implementations, there may not be any differences between an “identification template,” “activation data,” or an “activation vectors.” In such implementations, the activation data output by the hidden layer 154b is the activation data 160 and vector representation of that activation data 160 can be used as an identification template. In other implementations, there may relatively minor formatting differences that occur between the activation data 160, activation vector corresponding to activation data 160, and identification template corresponding to activation data 160 to facilitate their respective uses in different data processing systems. For example, data fields such as a header field may added to an activation vector when making the activation data into an identification template for storage. In any event, comparisons between newly generated activation data 160, which can synonymously be referred to as an activation vector or runtime identification template, and a stored identification template are made by evaluating the activation data output by a hidden layer 154b of a machine learning model 150 trained as described herein.

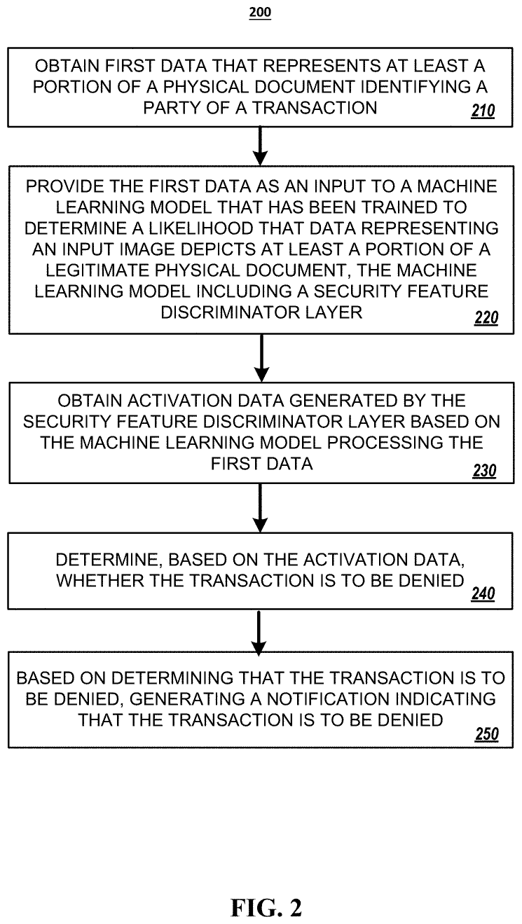

FIG. 2 is a flowchart of an example of a process 200 for generating identification templates. The process 200 may be performed by one or more electronic systems, for example, the system 100 of FIG. 1.

The system 100 can begin execution of the process 200 by obtaining, by one or more computers first data that represents at least a portion of a physical document identifying a party of a transaction (210). In some implementations, the obtained first data can include an input vector that represents at least portion of the physical document identifying a party of the transaction. The input data vector can be generated based on an image of a physical document identifying a party of the transaction that was generated by a user device such as a smartphone and transmitted to a server by the user device. The image can be received across one or more wired or wireless networks such as LAN, a WAN, a cellular network, the Internet, or a combination thereof. The captured image can depict all, or a portion of, the physical document identifying a party to a transaction.

The system 100 can continue execution of the process 200 by providing the first data as an input to a machine learning model that has been trained to determine a likelihood that data representing an input image depicts at least a portion of a legitimate physical document (220). In some implementations, the machine learning model can include a hidden security feature discriminator layer that has been trained to detect the presence or absence of one or more security features of an anticounterfeiting architecture upon which the machine learning model has been trained. In some implementations, the input vector obtained at stage 210 can be input to the machine learning model at stage 220.

The process 200 includes obtaining activation data generated by the security feature discriminator layer based on the machine learning model processing the first data (230). In some implementations, the security feature discriminator layer can be a hidden layer of the machine learning model that is positioned between an input layer of machine learning model and an output layer of the machine learning model. determining, by the one or more computers, that the obtained activation data matches second data stored in a database of entity records within a predetermined error threshold, wherein each entity record in the database of entity records corresponds to an entity whose transactions are to be denied for at least a predetermined amount of time.

They system 100 can continue execution of the process 200 by determining, based on the obtained activation data whether the transaction is to be denied (240). For example, the system 100 can determine whether the transaction is to be denied by searching a good-actor list storing previously generated activation data representing one or more physical documents for other parties to other transactions representing entities whose transactions are to be allowed, a bad-actor list storing previously generated activation data representing one or more physical documents for other parties to other transactions whose transactions are to be denied, or a combination of both to determine whether the obtained activation data is within a predetermined amount of error of any of the instances of activations data stored in the good-actor list, bad-actor list, or both.

Based on determining that the transaction is to be denied, the system 100 can generate a notification indicating that the transaction is to be denied (250). The system 100 can determine that a transaction is to be denied if the obtained activation data matches an instance of activation data stored in the bad-actor list within a predetermined amount of error. The notification, when transmitted to and processed by a user device, can cause the user device to render a notification on a display of the user device that outputs a message indicating that the transaction is to be denied. However, the notification need not be limited to graphical display on a screen of a user device. Instead, the system 100 can transmit a notification to the user device that, when received and processed by the user device, causes the user device to output an audio message indicating that the transaction is to be denied. In some implementations, both an audio notification and a displayed notification can be provided.

Alternatively, in other implementations, the system 100 can determined that the transaction is to be approved or permitted. The system 100 can determine that the transaction is to be approved if, for example, the system 100 determines that the obtained activation data matches an instance of activation data stored in the good-actor list within a predetermined amount of error. In such a scenario, the system 100 can generate a notification indicating that the transaction is to be approved. In this scenario, the notification, when transmitted to and processed by a user device, can cause the user device to render a notification on a display of the user device that outputs a message indicating that the transaction is to be denied. However, the notification need not be limited to graphical display on a screen of a user device. Instead, the system 100 can transmit a notification to the user device that, when received and processed by the user device, causes the user device to output an audio message indicating that the transaction is to be approved or permitted. In some implementations, both an audio notification and a displayed message can be provided.

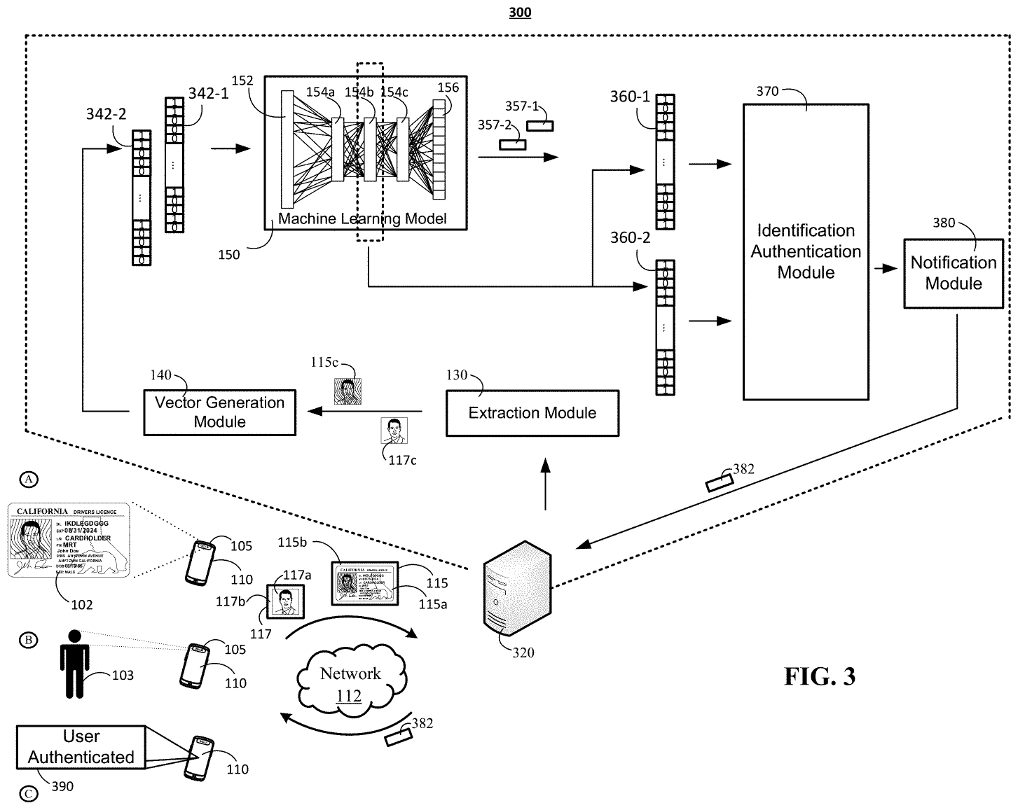

FIG. 3 is a contextual diagram of an example of a system 300 for authenticating a user's identity using identification templates. The system 300 includes many of the same features from system 100 of FIG. 1 such as physical document 102, the camera 105, the user device 110, the image 115, the server 320, the extraction module 130, the portion of the image 115a, the vector generation module 140, and the machine learning model 150. In addition, the system 300 also includes an identification authentication module 370 and notification module 380. In the example of FIG. 3, a process is shown from stage A to stage B to stage C.

With reference to the example of FIG. 3, the user device 110 can capture an image 115 of the physical document 102 using the camera 105 at stage A. The image 115 can include a first portion 115a that depicts at least a portion of the physical document 102 and a second portion 115b that depicts a portion of the surrounding environment when the image 115 of the physical document 102 was captured. The user device110 can transmit the image 115 to the server 320 using the network 112. The network 112 can include a wired network, a wireless network, a LAN, a WAN, a cellular network, the Internet, or any combination thereof.

Then, at stage B of FIG. 3, the user device 110 can use a camera 105 to capture an image 117 of the user 103. The image 117 depicts at least a portion of the body of the user 103. In some implementations, the image 117 can include a “selfie” image that depicts a face of the user 103. In some implementations, the image 117 can include a first portion 117a that depicts a portion of the body of the user 103 and a second portion 117b that depicts a portion of the surrounding environment when the image 117 of the user 103 was captured. The user device110 can transmit the image 117 to the server 320 using the network 112. The network 112 can include a wired network, a wireless network, a LAN, a WAN, a cellular network, the Internet, or any combination thereof.

In some implementations, the user device can include a smartphone. However, the present disclosure need not be so limited. For example, in some implementations, the user device 110 can include a camera without voice calling capabilities can be used to capture the images 115, 117. Then, the camera can transmit the images 115, 117 to the server 320 using the network 112. In other implementations, the camera without voice calling capabilities can capture the images 115, 117 and communicate the images 115, 117 to another a computer. This can be achieved via one or more networks such as a Bluetooth shortwave radio network or via a direct connection to the computer using, for example, a USBC cable. Then, in such implementations, the computer can be used to transmit the images 115, 117 to the server 320 using the network 112. In yet other implementations, the camera can be part of another user device such as a tablet, a laptop, smart glasses, a hand-held device with a camera, or the like, each of which can be equipped with a camera and image transmitting device. In general, any device capable of capturing images can be used to capture images such as the images 115, 117. In addition, there is no requirement that a single user device captures the images 115, 117. For example, a first user device such as a smartphone can capture the image 115 and then a second user device such as a pair of smart glasses could capture the image 117.

The user device 110 sends the image 115 captured at stage A to the server 320 using the network 112. The user device 110 also sends the image 117 captured at stage B to the server 320 using the network 112. In some implementations, the user device 110 captures the image 115, sends the image 115, captures the image 117, and then sends the image 117. However, the present disclosure is not limited to such a sequence of operations. For example, in some implementations, a user can be prompted by the user device 110 for an image 115 of a physical document 102 such as a driver's license and a selfie image 117. In such instances, a user of the user device 110 can access a stored image 115 of the physical document 102 and a stored selfie image 117 and upload the stored images 115, 117 to the server 320 using the network 112.

The server 320 is configured to use the extraction module 130, the vector generation module 140, and the machine learning model 150 on each of the images 115, 117 separately in order to generate a respective instance of activation data for each image 115, 117. In general, each of these modules operations on each of images 115, 117 in the same manner as described with respect to the example of FIG. 1 to generate an instance of activation data for each image 115, 117.

By way of example, with respect to FIG. 3, the server 320 can provide the image 115 as an input to the extraction module 130. The extraction module 130 can extract a first extracted image portion 115c of the image 115. In this example, the first extracted image portion 115c is the profile image of the person depicted by the image 115 of the physical document 102. The server 320 can then provide the first extracted image portion 115c as an input to the vector generation module 140. The vector generation module 140 can process the first extracted image portion 115c to generate a first input vector 342-1 that numerically represents the first extracted image portion 115c. For example, the vector 142 can include a plurality of fields that each correspond to a pixel of the first extracted image portion 115c. The vector generation module 140 can determine a numerical value for each of the fields that describes a corresponding pixel of the first extracted image portion 115c. The first extracted image portion 115c may also be referred to herein as the image 115c or the profile image 115c.

The server 320 can provide the generated first input vector 342-1 as an input to the machine learning model 150. The machine learning model 150 can process the first input vector 342-1 through each layer 152, 154a, 154b, 154c, 156 of the machine learning model 150 to generate output data 357-1, which can include a likelihood that the physical document 102 represented by the first input vector 342-1 is a counterfeit physical document. The server 320 can discard these output values and instead obtains first activation data 360-1 output by a hidden layer of the machine learning model 150 that has been trained, using the techniques described herein, to function as security feature discriminator layer. The first activation data 360-1 can be generated using the same techniques to generate the activation data 160 in the example of FIG. 1. This first activation data 360-1 serves as an identification template of the first extracted image 115c.

Likewise, the server 320 can provide the image 117 as an input to the extraction module 130. The extraction module 130 can extract a second extracted image portion 117c of the image 117. In this example, the second extracted image portion 117c is selfie image of the user 103 depicted by image 117. The server 320 can then provide the second extracted image portion 117c as an input to the vector generation module 140. The vector generation module 140 can process the second extracted image portion 117c to generate a second input vector 342-2 that numerically represents the second extracted image portion 117c. For example, the second input vector 342-2 can include a plurality of fields that each correspond to a pixel of the second extracted image portion 117c. The vector generation module 140 can determine a numerical value for each of the fields that describes a corresponding pixel of the second extracted image portion 117c. The second extracted image portion 117c can also be referred to herein as an image 117c or a selfie image 117c.

The server 320 can provide the generated second input vector 342-2 as an input to the machine learning model 150. The machine learning model 150 can process the second input vector 342-2 through each layer 152, 154a, 154b, 154c, 156 of the machine learning model 150 to generate output data 357-2, which can include a likelihood that the physical document 102 represented by the second input vector 342-2 is a counterfeit physical document. The server 320 can discard these output values and instead obtain second activation data 360-2 output by a hidden layer of the machine learning model 150 that has been trained, using the techniques described herein, to function as security feature discriminator layer. The second activation data 360-2 can be generated using the same techniques to generate the activation data 160 in the example of FIG. 1. This second activation data 360-2 serves as an identification template of the second extracted image 117c.

In the example shown in FIG. 3, the first activation data 360-1 and the second activation data 360-2 generated by the hidden security feature discriminator layer 154b of the machine learning model 150 and corresponding to the first input vector 342-1 and second input vector 342-2, respectively, can be provided as inputs to the identification authentication module 370. The identification authentication module 370 can determine a likelihood that the profile image 115c of the physical document 102 and the selfie image 117c of user 103 depict the same person.

The identification authentication module 370 can make this determination based on a comparison of the first activation data 360-1 and the second activation data 360-2. For example, the identification authentication module 370 can evaluate each respective set of activation data in a vector space. Then, the identification authentication module 370 can evaluate a distance between the first activation data 360-1 and the second activation data 360-2 in the vector space. If the identification authentication module 370 determines that the distance between the first activation data 360-1 and the second activation data 360-2 satisfies a predetermined error threshold, then the identification authentication module 370 can determine that the two identification templates are a match. In such instances, the identification authentication module can determine that user 103 has been authenticated.

After determining that the user has been authenticated, the identification authentication module 370 can instruct the notification module 380 to generate a notification 382 for transmission to the user device 110 indicating that the user has been authenticated. The notification 382 can be transmitted to the user device 110 across the network 112. The notification 382 can be configured to include rendering data that, when rendered by the user device 110, causes the user device 110 to display a notification on the display of the user device 110 that communicating to the user of the user device 110 that the user has been authenticated. Though this example has the authentication message being delivered back to the user device that captured the images 115, 117, the present disclosure need not be so limited. For example, in some implementations, one or more user devices can be used to capture and provide the images 115, 117 to the server 320 and then the server 320 can send the notification 382 to another different user device.

Alternatively, in some instances, if the identification authentication module 370 determines that the distance between the first activation data 360-1 and the second activation data 360-2 does not satisfy a predetermined error threshold, then the identification authentication module 370 can determine that the two identification templates are not a match. In such instances, the identification authentication module can determine that user 103 is not authenticated

After determining that the user is not authenticated, the identification authentication module 370 can instruct the notification module 380 to generate a notification for transmission to the user device 110 indicating that the user is not authenticated. The notification can be transmitted to the user device 110 across the network 112. The notification can be configured to include rendering data that, when rendered by the user device 110, causes the user device 110 to display a notification on the display of the user device 110 that communicating to the user of the user device 110 that the user has been authenticated. This notification may expressly indicate that the user is not authenticated or the lack of authentication can be more subtle such as denial of access to a service sought by the user for which user authentication was required. Though this example describes the authentication message being delivered back to the user device that captured the images 115, 117, the present disclosure need not be so limited. For example, in some implementations, one or more user devices can be used to capture and provide the images 115, 117 to the server 320 and then the server 320 can send the notification 382 to another different user device.

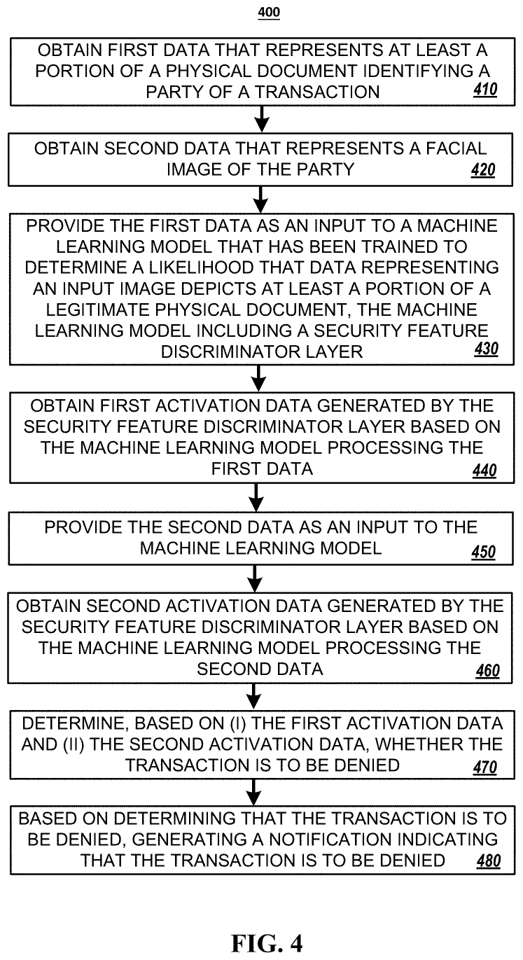

FIG. 4 is a flowchart of an example of a process 400 for authenticating a user using identification templates. The process 400 may be performed by one or more electronic systems, for example, the system 300 of FIG. 3.

The system 300 can begin performance of the process 400 by obtaining first data that represents at least a portion of a physical document identifying a party of a transaction (410). The first data can include, for example, a first input vector generated by a vector generation unit based on the vector generation unit processing a first image extracted from an image of a physical document.

The system 300 can continue performance of the process 400 by obtaining second data that represents a facial image of the party (420). The second data can include, for example, a second input vector generated by a vector generation unit based on the vector generation unit processing a “selfie” image of a user of a user device. The user may include a person seeking access to a service for which user authentication is required. The service can include an on-line application accessible through a browser or native application. By way of example, the service can include a game, a productivity application, an email account, a cable account profile, a cellular phone account profile, a cable account profile, a bank account, a utilities account, or any other service accessible for which user authentication is required.

The system 300 can continue performance of the process 400 by providing the first data as an input to a machine learning model that has been trained to determine a likelihood that data representing an input image depicts at least a portion of a legitimate physical document (430). In some implementations, the machine learning model can include a security feature discriminator layer. The security feature discriminator layer can be trained to detect, for each vector representing an input image of a physical document, the presence or absence of a security feature of an anticounterfeiting architecture upon which the security feature discriminator layer has been trained. The first data can include, for example, a first input vector generated by a vector generation unit based on the vector generation unit processing a first image extracted from an image of a physical document.

The system 300 can continue performance of the process 400 by obtaining first activation data generated by the security feature discriminator layer based on the machine learning model processing the first data (440). The first activation data can include the output of the hidden security feature discriminator layer during the machine learning model's processing of the first input vector that represent a first image extracted from an image of a physical document.

The system 300 can continue performance of the process 400 by providing the second data as an input to the machine learning model (450). The second data can include, for example, a second input vector generated by a vector generation unit based on the vector generation unit processing a “selfie” image of a user of a user device.

The process 400 includes obtaining second activation data generated by the security feature discriminator layer based on the machine learning model processing the second data (460). For example, the second activation data can include the output of the hidden security feature discriminator layer during the machine learning model's processing of the second input vector that represents a “selfie” image of a user of a user device

The system 300 can continue performance of the process 400 by determining, based on (i) the first activation data and (ii) the second activation data, whether a transaction is to be denied (470). Determining whether the transaction is to be denied can included, for example, determining a distances between the first activation data and the second activation data in a vector space. If the system 300 determines that the distance between the first activation data and the second activation data does not satisfy a predetermined threshold, then the system 300 can determine that the transaction is to be denied. In some implementations, the transaction can include a point-of-sale purchase, a request to change a feature of a service to which a user is subscribed, a request to access an online account, or the like.

Based on determining that the transaction is to be denied, the system 300 can continue performance of the process 400 by generating a notification indicating that the transaction is to be denied (480). For example, the system 300 can transmit a notification that, when rendered by a user device, causes the user device to display information indicating that the user is not authenticated, the transaction is denied, a combination thereof, or the like.

Alternatively, in some implementations, if the system 300 determines that the distance between the first activation data and the second activation data satisfies a predetermined threshold, then the system 300 can determine that the transaction should be permitted.

Based on determining that the transaction is to be permitted, the system 300 can continue performance of the process 400 by generation a notification indicating that the transaction is to be permitted. For example, the system 300 can transmit a notification that, when rendered by a user device, causes the user device to display information indicating that has been authenticated, the transaction is approved, provide access to an account setting, change a value of a parameter associated with user account, or the like.

Each of the notifications described above with reference to FIG. 4 describe notifications which cause the user device to display a notification. However, the notification need not be limited to graphical display on a screen of a user device. Instead, the system 300 can transmit a notification to the user device that, when received and processed by the user device, causes the user device to output an audio message indicating that the transaction is to be denied or permitted, that a user is authenticated or not authenticated, or the like. In some implementations, both an audio notification and a displayed notification can be provided.

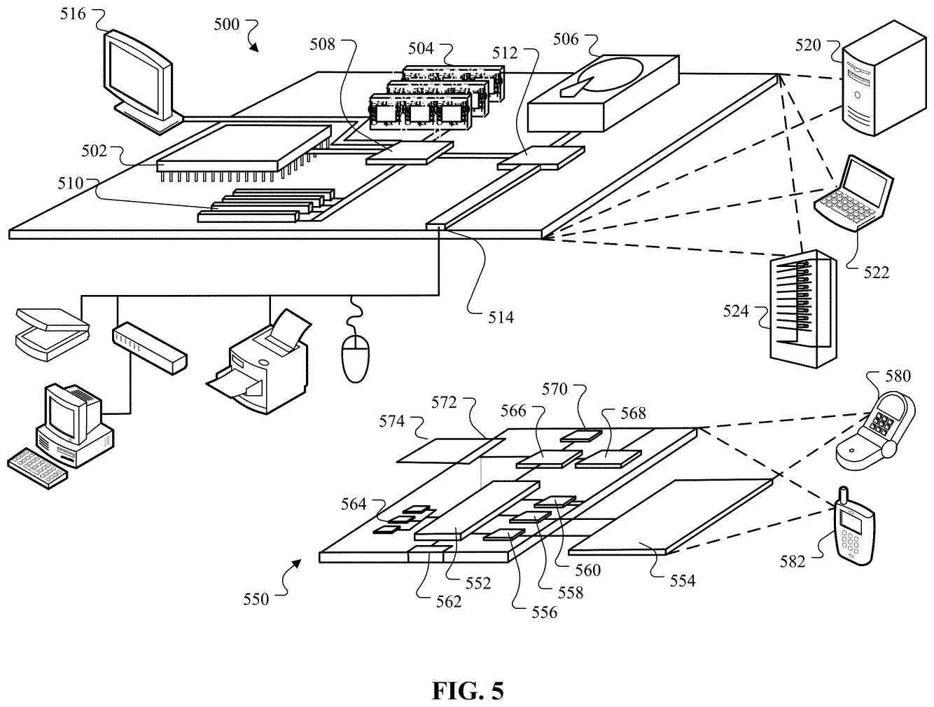

FIG. 5 is a block diagram of system 500 components that can be used to implement generate and use identification templates.

Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally, computing device 500 or 550 can include Universal Serial Bus (USB) flash drives. The USB flash drives can store operating systems and other applications. The USB flash drives can include input/output components, such as a wireless transmitter or USB connector that can be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and can be mounted on a common motherboard or in other manners as appropriate. The processor 502 can process instructions for execution within the computing device 500, including instructions stored in the memory 504 or on the storage device 508 to display graphical information for a GUI on an external input/output device, such as display 516 coupled to high speed interface 508. In other implementations, multiple processors and/or multiple buses can be used, as appropriate, along with multiple memories and types of memory. Also, multiple computing devices 500 can be connected, with each device providing portions of the necessary operations, e.g., as a server bank, a group of blade servers, or a multi-processor system.

The memory 504 stores information within the computing device 500. In one implementation, the memory 504 is a volatile memory unit or units. In another implementation, the memory 504 is a non-volatile memory unit or units. The memory 504 can also be another form of computer-readable medium, such as a magnetic or optical disk.

The storage device 508 is capable of providing mass storage for the computing device 500. In one implementation, the storage device 508 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The information carrier is a computer- or machine-readable medium, such as the memory 504, the storage device 508, or memory on processor 502.

The high speed controller 508 manages bandwidth-intensive operations for the computing device 500, while the low speed controller 512 manages lower bandwidth intensive operations. Such allocation of functions is exemplary only. In one implementation, the high-speed controller 508 is coupled to memory 504, display 516, e.g., through a graphics processor or accelerator, and to high-speed expansion ports 510, which can accept various expansion cards (not shown). In the implementation, low-speed controller 512 is coupled to storage device 508 and low-speed expansion port 514. The low-speed expansion port, which can include various communication ports, e.g., USB, Bluetooth, Ethernet, wireless Ethernet can be coupled to one or more input/output devices, such as a keyboard, a pointing device, microphone/speaker pair, a scanner, or a networking device such as a switch or router, e.g., through a network adapter. The computing device 500 can be implemented in a number of different forms, as shown in the figure. For example, it can be implemented as a standard server 520, or multiple times in a group of such servers. It can also be implemented as part of a rack server system 524. In addition, it can be implemented in a personal computer such as a laptop computer 522. Alternatively, components from computing device 500 can be combined with other components in a mobile device (not shown), such as device 550. Each of such devices can contain one or more of computing device 500, 550, and an entire system can be made up of multiple computing devices 500, 550 communicating with each other.

The computing device 500 can be implemented in a number of different forms, as shown in the figure. For example, it can be implemented as a standard server 520, or multiple times in a group of such servers. It can also be implemented as part of a rack server system 524. In addition, it can be implemented in a personal computer such as a laptop computer 522. Alternatively, components from computing device 500 can be combined with other components in a mobile device (not shown), such as device 550. Each of such devices can contain one or more of computing device 500, 550, and an entire system can be made up of multiple computing devices 500, 550 communicating with each other

Computing device 550 includes a processor 552, memory 564, and an input/output device such as a display 554, a communication interface 566, and a transceiver 568, among other components. The device 550 can also be provided with a storage device, such as a micro-drive or other device, to provide additional storage. Each of the components 550, 552, 564, 554, 566, and 568, are interconnected using various buses, and several of the components can be mounted on a common motherboard or in other manners as appropriate.

The processor 552 can execute instructions within the computing device 550, including instructions stored in the memory 564. The processor can be implemented as a chipset of chips that include separate and multiple analog and digital processors. Additionally, the processor can be implemented using any of a number of architectures. For example, the processor 510 can be a CISC (Complex Instruction Set Computers) processor, a RISC (Reduced Instruction Set Computer) processor, or a MISC (Minimal Instruction Set Computer) processor. The processor can provide, for example, for coordination of the other components of the device 550, such as control of user interfaces, applications run by device 550, and wireless communication by device 550.

Processor 552 can communicate with a user through control interface 558 and display interface 556 coupled to a display 554. The display 554 can be, for example, a TFT (Thin-Film-Transistor Liquid Crystal Display) display or an OLED (Organic Light Emitting Diode) display, or other appropriate display technology. The display interface 556 can comprise appropriate circuitry for driving the display 554 to present graphical and other information to a user. The control interface 558 can receive commands from a user and convert them for submission to the processor 552. In addition, an external interface 562 can be provide in communication with processor 552, so as to enable near area communication of device 550 with other devices. External interface 562 can provide, for example, for wired communication in some implementations, or for wireless communication in other implementations, and multiple interfaces can also be used.

The memory 564 stores information within the computing device 550. The memory 564 can be implemented as one or more of a computer-readable medium or media, a volatile memory unit or units, or a non-volatile memory unit or units. Expansion memory 574 can also be provided and connected to device 550 through expansion interface 572, which can include, for example, a SIMM (Single In Line Memory Module) card interface. Such expansion memory 574 can provide extra storage space for device 550, or can also store applications or other information for device 550. Specifically, expansion memory 574 can include instructions to carry out or supplement the processes described above, and can include secure information also. Thus, for example, expansion memory 574 can be provide as a security module for device 550, and can be programmed with instructions that permit secure use of device 550. In addition, secure applications can be provided via the SIMM cards, along with additional information, such as placing identifying information on the SIMM card in a non-hackable manner.

The memory can include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that can be received, for example, over transceiver 568 or external interface 562.

Device 550 can communicate wirelessly through communication interface 566, which can include digital signal processing circuitry where necessary. Communication interface 566 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 568. In addition, short-range communication can occur, such as using a Bluetooth, Wi-Fi, or other such transceiver (not shown). In addition, GPS (Global Positioning System) receiver module 570 can provide additional navigation- and location-related wireless data to device 550, which can be used as appropriate by applications running on device 550.

Device 550 can also communicate audibly using audio codec 560, which can receive spoken information from a user and convert it to usable digital information. Audio codec 560 can likewise generate audible sound for a user, such as through a speaker, e.g., in a handset of device 550. Such sound can include sound from voice telephone calls, can include recorded sound, e.g., voice messages, music files, etc. and can also include sound generated by applications operating on device 550.

The computing device 550 can be implemented in a number of different forms, as shown in the figure. For example, it can be implemented as a cellular telephone 580. It can also be implemented as part of a smartphone 582, personal digital assistant, or other similar mobile device.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor for displaying information to the user and a keyboard and a pointing device, e.g., a mouse or a trackball by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A system for transaction verification, comprising:
one or more processors; and
one or more storage devices, wherein the one or more storage devices includes instructions that, when executed by the one or more processors, cause the one or more processors to perform operations, the operations comprising:
obtaining, by one or more computers, first data that represents at least a portion of a physical document identifying a party of a transaction;
providing, by the one or more computers, the first data as an input to a machine learning model that comprises a security feature discriminator layer that is configured to detect the presence of one or more security features in data representing an image of at least a portion of a physical document or the absence of one or more security features in data representing an image of at least a portion of a physical document;
obtaining, by the one or more computers, activation data generated by the security feature discriminator layer based on the machine learning model processing the first data;
determining, by the one or more computers and based on the obtained activation data, that the transaction is to be denied; and
based on determining that the transaction is to be denied, generating, by the one or more computers, a notification that, when processed by the computer, causes the computer to output data indicating that the transaction is to be denied.

2. The system of claim 1, wherein determining, by the one or more computers and based on the obtained activation data, that the transaction is to be denied comprises:
determining, by the one or more computers, that the obtained activation data matches second data stored in a database of entity records within a predetermined error threshold, wherein each entity record in the database of entity records corresponds to an entity whose transactions are to be denied for at least a predetermined amount of time.

3. The system of claim 1, wherein the operations further comprise:
obtaining, by one or more computers, third data that represents at least a portion of a physical document identifying a different party of a different transaction;
providing, by the one or more computers, the third data as an input to the machine learning model;
obtaining, by the one or more computers, different activation data generated by the security feature discriminator layer based on the machine learning model processing the third data;
determining, by the one or more computers and based on the obtained different activation data that the transaction is not to be denied; and
based on determining that the transaction is not to be denied, generating, by the one or more computers, a notification that, when processed by the computer, causes the computer to output data indicating that the transaction is not to be denied.

4. The system of claim 3, wherein determining, by the one or more computers and based on the obtained different activation data that the transaction is not to be denied comprises:
determining, by the one or more computers, that the obtained different activation data matches fourth data stored in a database of entity records within a predetermined error threshold, wherein each entity record in the database of entity records corresponds to an entity whose transactions are to be authorized for at least a predetermined amount of time.

5. The system of claim 3, wherein determining, by the one or more computers and based on the obtained different activation data that the transaction is not to be denied comprises:
determining, by the one or more computers, that the obtained different activation data does not match data stored in a database of entity records within a predetermined error threshold, wherein each entity record in the database of entity records corresponds to an entity whose transactions are to be denied for at least a predetermined amount of time.

6. The system of claim 1, the operations further comprising:
obtaining, by the one or more computers, output data generated by the machine learning model based on the machine learning model processing the first data, wherein the output data indicates a likelihood that the first data represents an image that depicts at least a portion of a legitimate physical document.

7. The system of claim 1, wherein the security feature discriminator layer is a hidden layer of the machine learning model.

8. The system of claim 1, wherein the machine learning model comprises one or more neural networks.

9. The system of claim 1, the operations further comprising:
receiving, by the security feature discriminator layer, second data representing at least the portion of a physical document identifying a party of a transaction;
generating, using the security feature discriminator layer, the activation data, wherein generating the activation data comprising:
encoding, using the security feature discriminator layer, data representing the presence of one or more security features in the second data or the absence of one or more security features in the second data.

10. A method for transaction verification, comprising:
obtaining, by one or more computers, first data that represents at least a portion of a physical document identifying a party of a transaction;
providing, by the one or more computers, the first data as an input to a machine learning model that comprises a security feature discriminator layer that is configured to detect the presence of one or more security features in data representing an image of at least a portion of a physical document or the absence of one or more security features in data representing an image of at least a portion of a physical document;
obtaining, by the one or more computers, activation data generated by the security feature discriminator layer based on the machine learning model processing the first data;
determining, by the one or more computers and based on the obtained activation data, that the transaction is to be denied; and
based on determining that the transaction is to be denied, generating, by the one or more computers, a notification that, when processed by the computer, causes the computer to output data indicating that the transaction is to be denied.

11. The method of claim 10, wherein determining, by the one or more computers and based on the obtained activation data, that the transaction is to be denied comprises:
determining, by the one or more computers, that the obtained activation data matches second data stored in a database of entity records within a predetermined error threshold, wherein each entity record in the database of entity records corresponds to an entity whose transactions are to be denied for at least a predetermined amount of time.

12. The method of claim 10, wherein the method further comprising:
obtaining, by one or more computers, third data that represents at least a portion of a physical document identifying a different party of a different transaction;
providing, by the one or more computers, the third data as an input to the machine learning model;
obtaining, by the one or more computers, different activation data generated by the security feature discriminator layer based on the machine learning model processing the third data;
determining, by the one or more computers and based on the obtained different activation data that the transaction is not to be denied; and
based on determining that the transaction is not to be denied, generating, by the one or more computers, a notification that, when processed by the computer, causes the computer to output data indicating that the transaction is not to be denied.

13. The method of claim 12, wherein determining, by the one or more computers and based on the obtained different activation data that the transaction is not to be denied comprises:
determining, by the one or more computers, that the obtained different activation data matches fourth data stored in a database of entity records within a predetermined error threshold, wherein each entity record in the database of entity records corresponds to an entity whose transactions are to be authorized for at least a predetermined amount of time.

14. The method of claim 12, wherein determining, by the one or more computers and based on the obtained different activation data that the transaction is not to be denied comprises:
determining, by the one or more computers, that the obtained different activation data does not match data stored in a database of entity records within a predetermined error threshold, wherein each entity record in the database of entity records corresponds to an entity whose transactions are to be denied for at least a predetermined amount of time.

15. The method of claim 10, the method further comprising:
obtaining, by the one or more computers, output data generated by the machine learning model based on the machine learning model processing the first data, wherein the output data indicates a likelihood that the first data represents an image that depicts at least a portion of a legitimate physical document.

16. The method of claim 10, the method further comprising:
receiving, by the security feature discriminator layer, second data representing at least the portion of a physical document identifying a party of a transaction;
generating, using the security feature discriminator layer, the activation data, wherein generating the activation data comprising:
encoding, using the security feature discriminator layer, data representing the presence of one or more security features in the second data or the absence of one or more security features in the second data.

17. A non-transitory computer-readable medium storing software comprising instructions executable by one or more computers which, upon such execution, cause the one or more computers to perform operations comprising:
obtaining, by one or more computers, first data that represents at least a portion of a physical document identifying a party of a transaction;
providing, by the one or more computers, the first data as an input to a machine learning model that comprises a security feature discriminator layer that is configured to detect the presence of one or more security features in data representing an image of at least a portion of a physical document or the absence of one or more security features in data representing an image of at least a portion of a physical document;
obtaining, by the one or more computers, activation data generated by the security feature discriminator layer based on the machine learning model processing the first data;
determining, by the one or more computers and based on the obtained activation data, that the transaction is to be denied; and
based on determining that the transaction is to be denied, generating, by the one or more computers, a notification that, when processed by the computer, causes the computer to output data indicating that the transaction is to be denied.

18. The computer-readable medium of claim 17, wherein determining, by the one or more computers and based on the obtained activation data, that the transaction is to be denied comprises:
determining, by the one or more computers, that the obtained activation data matches second data stored in a database of entity records within a predetermined error threshold, wherein each entity record in the database of entity records corresponds to an entity whose transactions are to be denied for at least a predetermined amount of time.

19. The computer-readable medium of claim 17, wherein the operations further comprise:
obtaining, by one or more computers, third data that represents at least a portion of a physical document identifying a different party of a different transaction;
providing, by the one or more computers, the third data as an input to the machine learning model;
obtaining, by the one or more computers, different activation data generated by the security feature discriminator layer based on the machine learning model processing the third data;
determining, by the one or more computers and based on the obtained different activation data that the transaction is not to be denied; and
based on determining that the transaction is not to be denied, generating, by the one or more computers, a notification that, when processed by the computer, causes the computer to output data indicating that the transaction is not to be denied.

20. The computer-readable medium of claim 17, the operations further comprising:
receiving, by the security feature discriminator layer, second data representing at least the portion of a physical document identifying a party of a transaction;
generating, using the security feature discriminator layer, the activation data, wherein generating the activation data comprising:
encoding, using the security feature discriminator layer, data representing the presence of one or more security features in the second data or the absence of one or more security features in the second data.
